(19) United States
(12) Patent Application Publication
(10) Pub. No.: US 2013/0157494 A1
(43) Pub. Date: Jun. 20, 2013

(54) Coaxial Connector and Method of Operation

(71) Applicant: Gunsang Lim, Maumelle, AR (US)

(72) Inventor: Gunsang Lim, Maumelle, AR (US)

(21) Appl. No.: 13/772,641

(22) Filed: Feb. 21, 2013

(51) Int. Cl. H01R 4/56

(52) U.S. Cl. 439/320

(57) ABSTRACT

A coaxial connector for connecting an end of coaxial cable to a threaded port, comprising a post, a nut, a connector body and fastener members has been revised to improve connector's electrical and mechanical characteristics. The new features of the invention include a post and insertion engagement tools. The post has a first end, a second end, a circular passageway placed between first end and second end, at least two different diameters in the circular passageway wherein, in a cable-connector assembly, the first end is adapted to be inserted into a cable end and the second end opening is adapted to be a forced fit with the cable core wherein the said forced fit secures uninterrupted current flow at a high frequency through the core's outer conductor and seals the electromagnetic interference leak through the gap between the second end opening and cable core.

### CROSS REFERENCE TO RELATED APPLICATIONS

Equations used: Short line reflection coefficient and its use for compensating discontinuity capacitance. Amphenol Corporation, N. Sladek 1960.

### BACKGROUND OF THE INVENTION

1. Field of the invention
The present application relates to coaxial cable connectors and its electrical as well as mechanical performance specifically related to a post member. Art of relevance are classified in U.S. Pat. No. Class 439, Subclasses 578, 583, 584 and 585.

2. Description of the related art
The coaxial connectors of the present application are pertained to most of coaxial connectors, where a connector comprises a nut member, a post member, a connector body member, and fastener members for all types of coaxial connectors which have post members and longitudinally compressive mechanism or radially clamping mechanism, using suitable installation hand tools. There are two common problems in this type of connectors. See prior arts in FIG. 1C, FIG. 2A and FIG. 2B.

A. Electrical Characteristic Problems as a Transmission Line
In the past, coaxial cables were constructed with center conductor, coaxial insulation, coaxial braid, and coaxial outmost jacket. At present time, majority of coaxial cables were constructed with center conductor, coaxial insulation, coaxial laminated shield tape, coaxial braid and coaxial outmost jacket. A coaxial cable connector comprising a post member has a unique problem. At high frequency, by skin effect, laminated shield tape which is the first outer conductor, is a major current path. There is a gap between post inside wall and outside surface of laminated shield tape covered core. There is an uncertainty in current continuity between them. A post having a first end, a second end, a flange proximate the second end; a circular passageway placed between first end and second end, Post inside surface 203, FIG. 2B is usually plated metallic material and core surface 204, FIG. 1C is laminated shielding tape. When a cable and connector are fully assembled, since core outside diameter 202, FIG. 1C is smaller than post inside diameter 201, FIG. 2B, in the longitudinal distance 200, FIG. 2A, core surface 204, FIG. 1C does not make secure contact to post inside wall surface 203, FIG. 2B. When 206, FIG. 2A transverse electromagnetic wave supporting current, propagate through the cable toward nut; from the plane 205, wave propagation mode is no longer guaranteed as a normal transverse electromagnetic mode, because transverse electromagnetic mode supporting conductive current 206 flows only through the post as FIG. 2A. Inside surface of laminated shielding tape 198 is the first outer conductor of a cable but longitudinal distance of 200 from the plane 205 this long phase length is isolated from the signal propagation. For an example, if a post length is 20 mm, at high frequency as 3 Giga Hertz, phase length is 7.2 degrees, a significantly long phase length is isolated. Even though some points of core surface touch the post inside wall, there is no pressure between touching points and it can not be considered as a solid electrical continuity. The isolated insecure electrical length 200 creates frequency correlated electromagnetic disturbances. This propagation mode could get worse by vibration and metallic surface deterioration in time.
See enlarged section A of FIG. 2A. As second problem, through the gap between post inside surface 203 and core outside surface 204, electromagnetic interference 207 leaks in or out.
Briefly, these all causes contribute to
   (1) constant or intermittent high return loss and hazardous electromagnetic noises to digital and analog signal transmission system.
   (2) through the gap between post inside wall and core outside surface, electromagnetic noise leaks take place.

B. Mechanical Problem
In connector assembling operation, prepared cable's core insertion engagement with the first end of connector post is difficult. To assemble a coaxial cable to a connector, a cable end must be prepared as FIG. 1C. A prepared cable end has exposed center conductor, dielectric core covered by laminated shielding tape and cable jacket with braid wires folded back 187 over jacket. Post member's cylindrical sharp end is adapted to be inserted into prepared cable end around the core, and coaxially beneath said conductive braid without damage of core is difficult because
   (1) core outside diameter is very close in size to post member inside diameter and cut section core is not accurate circular shape to fit post circular end shape.
   (2) this operation is carried out in blind because post member end is located several mm inside of connector opening.

### BRIEF SUMMARY OF INVENTION

From the background of invention, 2 major problems were identified.

A. Electrical Characteristic Problems as a Transmission Line
(1) Intermittent hazardous electromagnetic noises to digital and analog signal transmission system.
(2) Through the gap between post inside wall and core outside surface, electromagnetic leaks take place.

B. Mechanical Problem; in Connector Assembling Operation,
(1) Prepared cable core's engagement into connector post end is difficult.
(2) Frequently, core end is damaged by sharp end of post member.

To resolve the above identified problems, post and insertion engagement tools are invented.

See FIG. 1A, FIG. 1B, FIG. 1C, FIG. 1D and FIG. 1E.

Post

Post members' first end diameter 201 receives prepared cable's core diameter 202 in clearance fit and post's second opening 209 inner surface 197 has forced fit with prepared cable 204; after cable and connector are assembled current 206 flows laminated shielding tape 198 and post 203 in parallel. Since, said forced fit between post second opening 197 and cable core 204 secures electrical continuity, there is no isolation of cable core inside of post from signal propagation as prior art, transverse electromagnetic mode is well reserved.

Post's second opening 209 has edgy 210 having shape and surface finish adapted to be used for cleaning, resizing outside surface of 204 and normalizing shape of prepared cable's core 204 before performing next connector cable assembly operation. In next operation surface 197 and 204 rubbed each other second time and enhance electrical continuity.

Insertion Engagement Tools

For easier engagement of cable core into post and reduce core damage, an insertion engagement tools 183 and 193 are invented. See FIG. 1D and FIG. 1E. Illustrations in FIG. 3B and FIG. 3C show how they work.

Engineering Review of Transmission Line of Connector

See FIG. 1A, FIG. 1B, FIG. 1C, FIG. 1D, 1E, FIG. 4A and FIG. 4B.

Once a connector is fully assembled, in FIG. 1A, cable's core end 196 and post's second end flange face 195 are flush and post's inside surface 197 and core's outside 204 make a forced fit for a secure electrical continuity. A return loss by forced fit region, 208 reviewed. See FIG. 4A and FIG. 4B.

Characteristic Impedance Calculation

As an example, a RG6 connector is selected.

| core dia | dielectric | conductor | | | impedance |
|---|---|---|---|---|---|
| mm | mm | mm | Er | root of Er | ohm |
| 4.73 | 4.52 | 1.02 | 1.44 | 1.20 | 74.5 |

Equation

Za=138 *log(4.52/1.02)/(root of Er)=74.5 ohm

In this calculation characteristic impedance at force fit area is 74.5 ohms

Return loss Calculation

See FIG. 4A and FIG. 4B.

Legends

Zs: system impedance 75 Ohm

Za: impedance at interested area Ohm

B: phase constant at Za region: radian/meter

S: longitudinal distance of interested area meter

Ksa: reflection coefficient looking toward Za at point s-a.

Kas: reflection coefficient looking toward Zs at point a-s.

Kt: total reflection coefficient

RL: return loss -dB

Equations

Kt=(Ksa+Kas* EXP(−j2BS))/(1+Ksa*Kas*EXP(−j2BS))

When S is short distance;

Approximation can be made.

Kt=(jBS(2Ksa/(1-(Ksa*Ksa))))

RL=−20*log(Kt)

| S | frequency | Zs | Za | B | | | RL |
|---|---|---|---|---|---|---|---|
| meter | giga Herts | ohm | ohm | rad/meter | Ksa | Kt | dB |
| 0.003 | 3 | 75 | 74.5 | 62.800 | −0.003 | 0.001 | 57.99 |

Return loss by the forced fit region is 57.99 db.

Brief description of cable connector assembly

See FIG. 1B, 1C, FIG. 3A, FIG. 3B and FIG. 3C.

Step 1

Prepare cable as 192; center conductor 190, core and braid wires back over jacket 187.

Resize, reshape, and surface cleaning 204 by inserting prepared cable into opening 209 about 6 mm and remove.

Step 2

Insert cable 192 into opening 201 and press in all the way until core's surface 196 flush to flange surface 195.

Use insertion engagement tool 183 or 193 for an engagement.

Conclusion

In this cable-connector assembly operation, the prepared cable end is pushed through the post first end opening until the core end flushes to post second end flange and the forced fit between core outside diameter and post secures electrical continuity; it achieves transverse electromagnetic mode and prevents electromagnetic interference leak 207 of FIG. 2A.

According to the above return loss calculation, return loss by the forced fit region is 57.99 db and is acceptable.

### BRIEF DESCRIPTION OF THE SEVERAL VIEWS OF THE DRAWING

FIG. 1A is a longitudinal cross-sectional view of a preferred embodiment of a connector according to the present invention, illustrating transverse electromagnetic mode supporting conductive current flows through laminated shielding tape in high frequency. A forced fit between core surface and post inside wall near the post flange secures the electrical continuity and prevents electromagnetic noise generation and its leaks.

FIG. 1B is a longitudinal cross-sectional view of the post member of the connector of the FIG. 1A. Post has a reduced inside diameter near the post flange.

FIG. 1C is a longitudinal cross-sectional view of prepared cable, comprising exposed center conductor, laminated shielding tape covered core, and cable jacket with braid combed back.

FIG. 1D is a present invention showing an insertion engagement tool, that the length is longer than uncompressed connector.

FIG. 1E is a present invention showing an insertion engagement tool, that the length is longer than exposed center conductor of a prepared cable.

FIG. 2A is a prior art of longitudinal cross-sectional view of the connector. Through the longitudinal length of the post, there are gaps between post inside wall and laminated shielding tape of a core and the transverse electromagnetic mode is not warranted in the loose fit region at a high frequency.

FIG. 2B is a prior art of longitudinal cross-sectional view of a post.

FIG. 3A shows a surface cleaning, sizing and reshaping operation of prepared cable's core, using connector second opening's smooth edge and reduced diameter of the post, before inserting a cable to a connector first opening.

FIG. 3B shows insertion of a prepared cable into a connector with a tool 183 in cable and connector assembling operation.

FIG. 3C shows insertion of a prepared cable into a connector with a tool 193 in cable and connector assembling operation.

FIG. 4A is a longitudinal cross-sectional view of a preferred embodiment of a connector according to the present invention.

FIG. 4B is cross-sectional view of the forced fit area S that secures electrical continuity and prevents electromagnetic leak.

FIG. 5 is exploded view of components of a connector.

FIG. 6 is an enlarged, longitudinal sectional view of the preferred post with more details

FIG. 7 is an enlarged, longitudinal cross-sectional view of the connector nut with more details.

FIG. 8 is an enlarged, longitudinal sectional view of the connector body with more details.

FIG. 9A is an enlarged, frontal view of the connector grommet

FIG. 9B is an enlarged cross-sectional view of FIG. 9A at section A-A with more details.

FIG. 10 is an enlarged, longitudinal cross-sectional view of the connector rear cap with more details.

### DETAILED DESCRIPTION OF THE INVENTION

This invention is applicable to all types of coaxial connector which comprises a post member. In this detailed description of the invention, a Perfect 10 connector, PV6UE-05 is selected for an example.

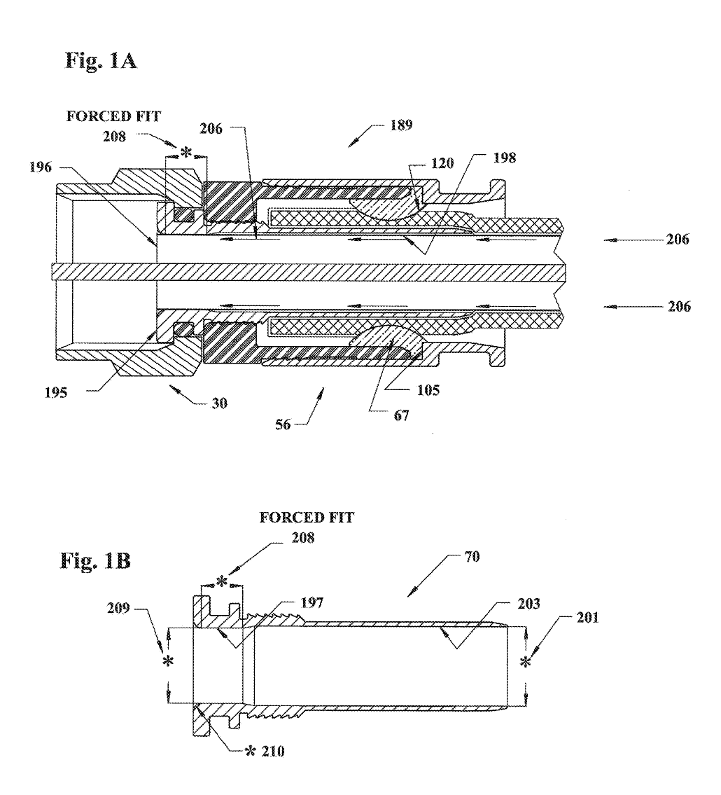

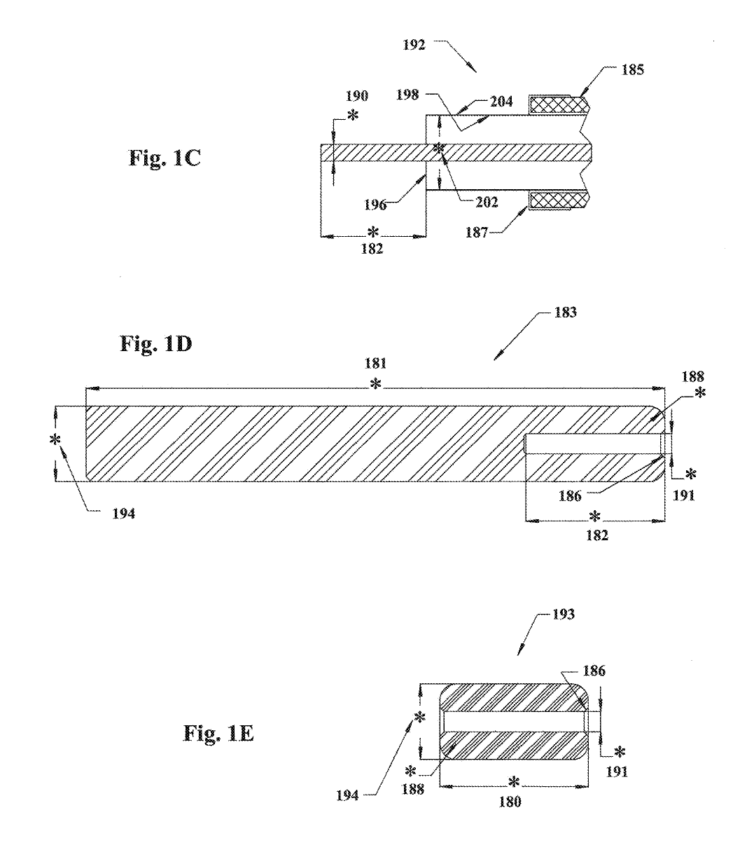

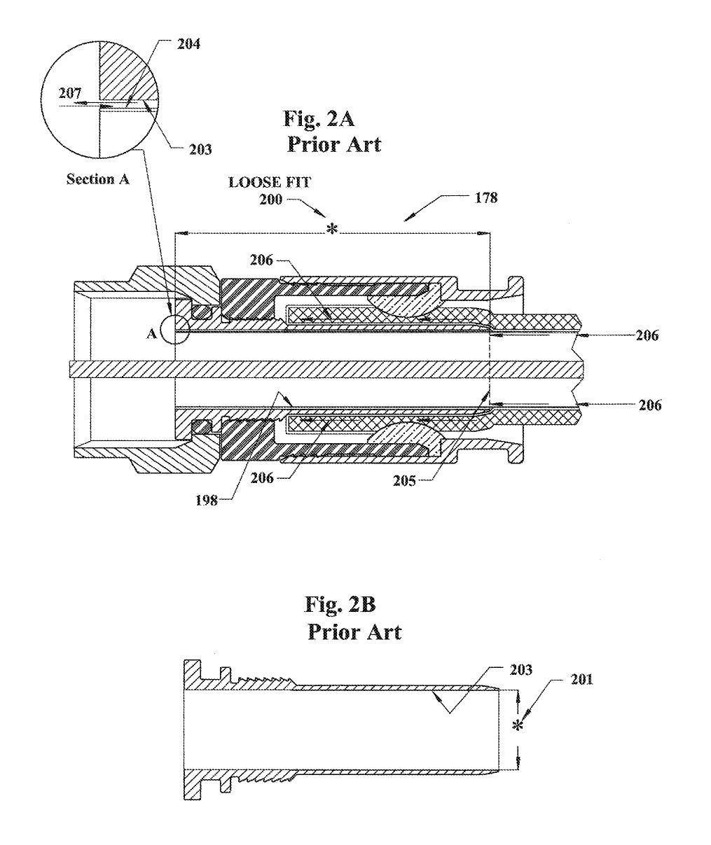

After a prepared end of coaxial cable is properly inserted through the open end 100 of an open connector, the connector is placed within a suitable compression hand tool for compression, substantially assuming the closed configuration of FIG. 1A. With additional reference directed to FIG. 1A and FIG. 5, the preferred rigid, tubular metallic nut 30 has a conventional faceted, preferably hexagonal drive head 32 integral with a protruding, coaxial stem 33.

Conventional internal threads 35 are defined in the nut or head interior for rotatable, threadable mating attachment to as a suitably threaded socket. The front opening 28 of the connector appears at the front of stem 33 surrounded by annular from face 34. A circular passageway 37 is concentrically defined in the faceted drive head 32 at the rear of nut 30. Passageway 37 is externally, coaxially bounded by the outer, round peripheral wall 38 forming a flat, circular end of the connector nut 30. An inner, annular shoulder 39 on the inside of head 32 is spaced apart from and parallel with outer wall 38. A leading chamfer 40 and a spaced part rear chamfer 41 defined on hex head 32 are preferred for easy handling.

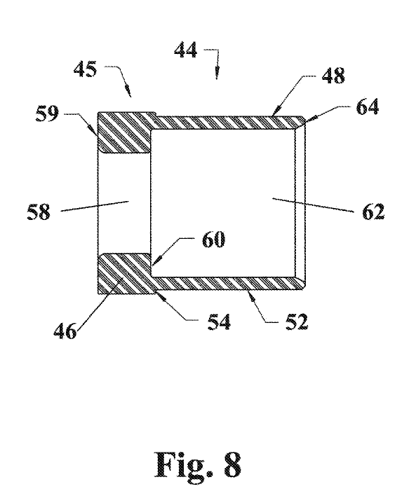

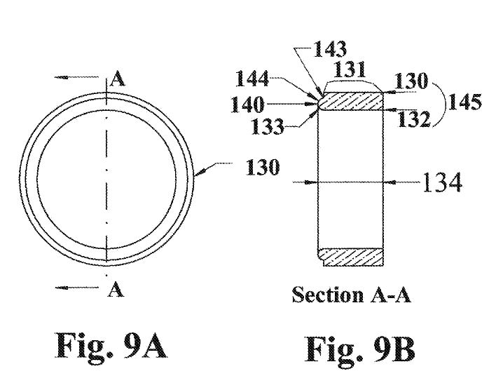

An elongated, tubular body 44 preferably molded from plastic is rotatably coupled to the nut 30. Body 44 preferably comprises a tubular stop ring 46 that is integral with reduced diameter shank 48 sized fit as illustrated in FIG. 8. The elongated, outer periphery 52 of shank 48 is smooth and cylindrical. The larger diameter stop ring 46 has an annular, rear wall 54 that is coaxial with shank 48. An end cap 56 is pressed unto body 44, coaxially engaging shank 48. The end cap 56 discussed hereinafter will smoothly, frictionally grip body 44 along and upon any point upon body shank 48, with maximum travel or displacement limited by stop ring 46. In other words, when the end cap 56 is compressed unto the body of connector and the connector assumes a closed position; annular wall 54 on the body stop ring 46 will limit maximum deflection or travel of the end cap 56. The resilient, preferably molded plastic body 44 is hollow stop ring 46 has an internal, coaxial passageway 58 extending from the annular front face 59 defined at the body front a major portion of the ring length. Passageway 58 extends to an inner, annual wall 60 that coaxially border another passageway 62, which has a larger diameter that passageway 58. The elongated passageway 62 is coaxially defined inside shank 48 and extends to rear, annular surface 64 coaxially located at the rear end of the shank 48. For moisture sealing, it is preferred that generally annular sealing grommet 67 be employed. The enhanced sealing grommet 67 is coaxially disposed within end cap 56 as explained in detail hereinafter.

With primary reference directed now to the post 70 rotatably, mechanically couples the hex headed nut 30 to the plastic body 44. The metallic post 70 also establishes electrical contact between the braid of the coax cable and the nut 30. The tubular post 70 defines an elongated shank 71 with a coaxial, internal passageway 72 extending its front 73 and rear 74. A front annular flange 76 is spaced apart from an integral, reduced diameter flange 78, across a ring groove 80. A conventional 0-ring 82 is preferably seated within ring groove 80 when the connector is assembled. Post external barbs 86 is press fitted into the body 44, frictionally scatting within passageway 58. In assembly it is also noted that post flange 76 axially contacts inner head wall 39. Inner post flange 78 axially abuts front face 59 of body 44 with post 70 penetrating passageway 58. The sealing 0-ring 82 is circumferentially frictionally constrained within nut 30 coaxially inside passageway 37. The post member has been revised to improve coaxial cable connector's electrical and mechanical characteristics. The post including a first end 74, a second end 73, and a flange 76 proximate the second end 73; circular passageways 69, 68 and 72 is placed between first end and second end; the new feature of invention is that the circular passageway has at least two different diameters; in FIG. 1C, the first end receives cable core, 204 and penetrates between braid, 187 and core of a cable and second end opening, inside surface 197 makes a forced fit with cable core surface, 204 in assembly operation; said forced fit between post second opening and cable core secures electrical continuity. This prevents isolation of the first outer conductor of cable region, 200, laminated shielding tape 198 from signal propagation and secures transmission line to preserve transverse electromagnetic mode. To facilitate insertion engagement of cable core into post and reduce core damage, an insertion pilot tool 183 and 193 are invented.

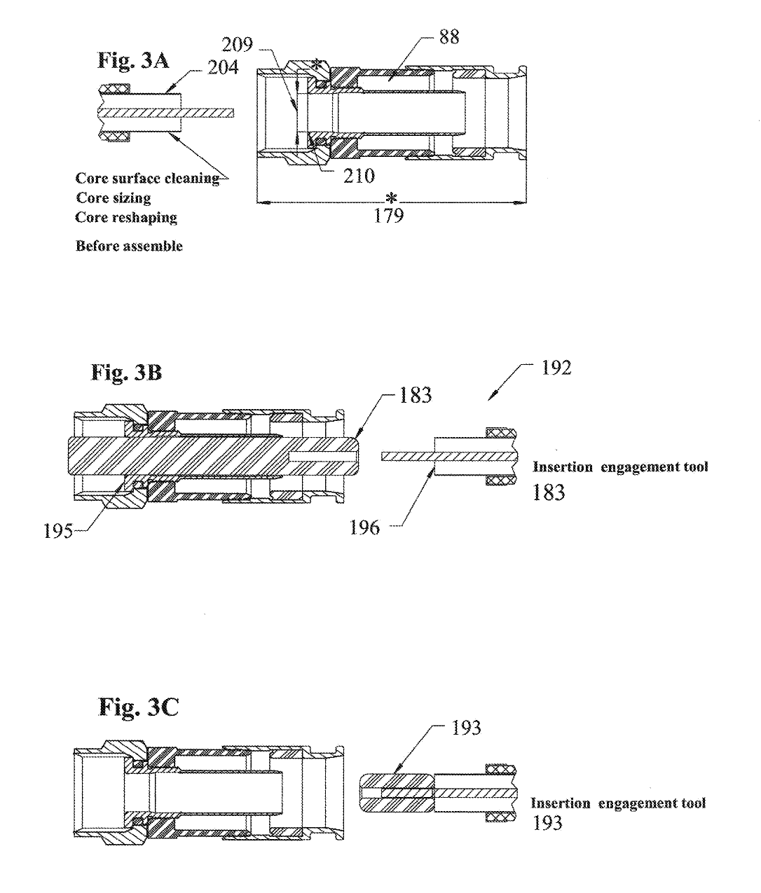

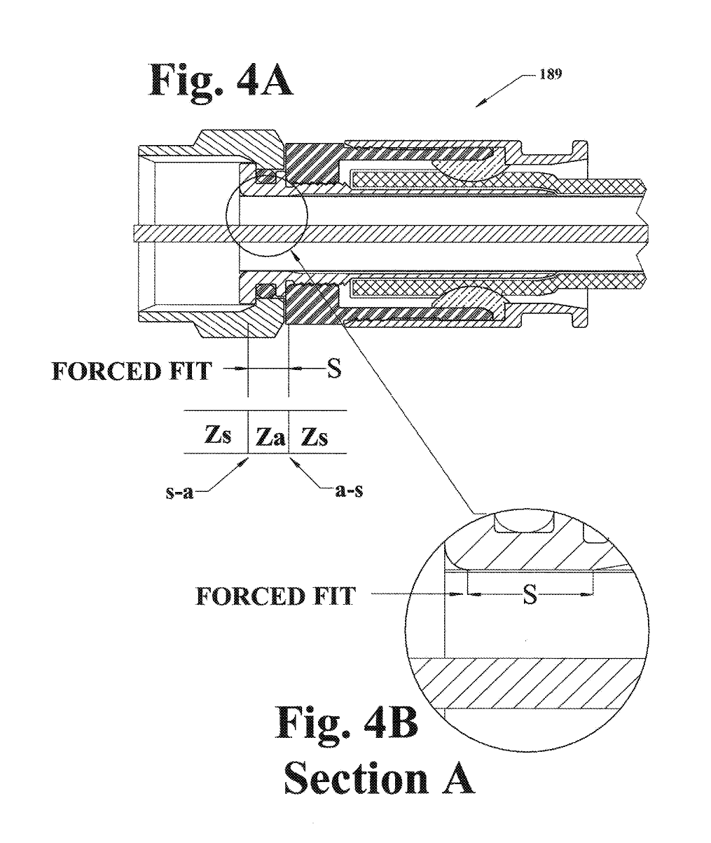

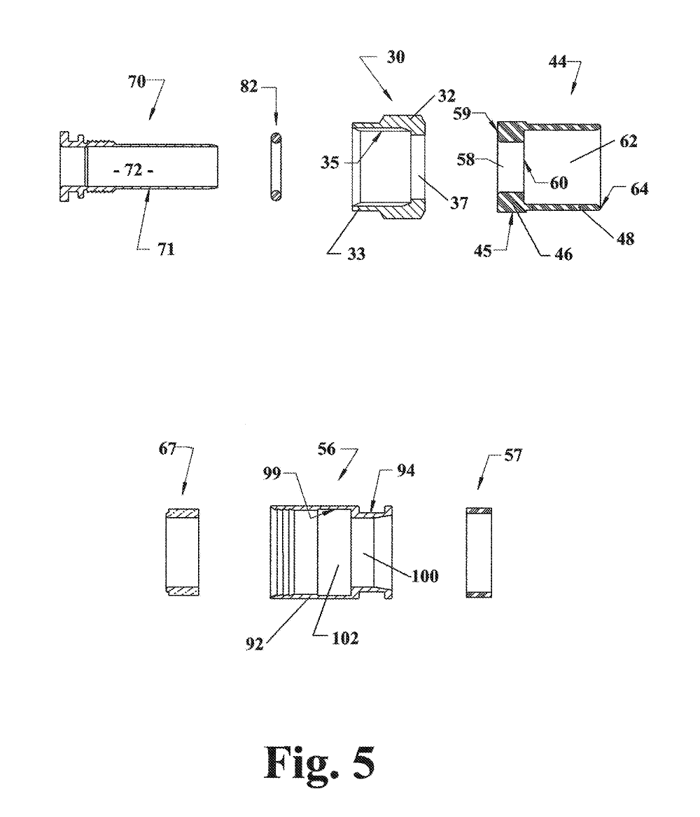

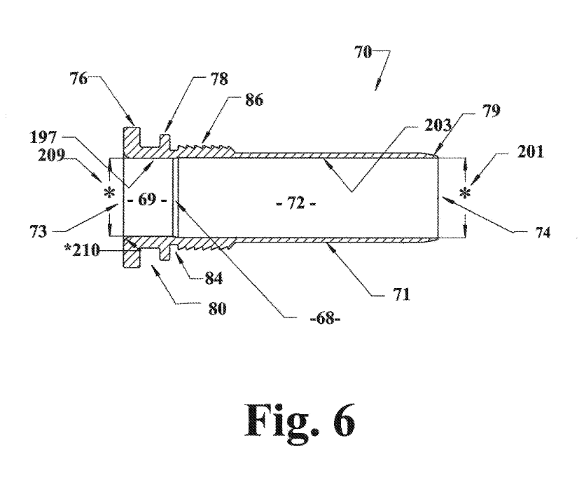

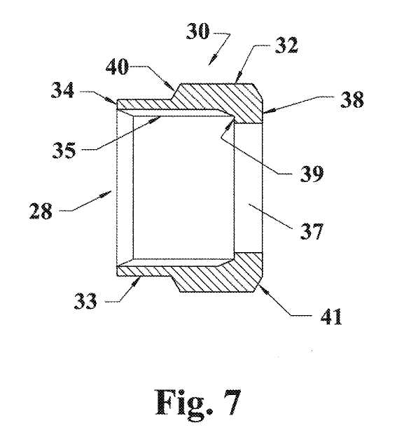

A prepared cable insertion engagement tool 183 having rod shape, first end and second end with length 181, FIG. 1D, longer than an uncompressed connector length 179, FIG. 3A, wherein outside diameter 194 is clearance fit with inside diameter 209 of the said connector post; first end has round finish 188, FIG. 1D around rod and center hole chamfer 186, wherein center hole diameter 191 is clearance fit with the cable's center conductor 190; center hole depth 182 is deeper than exposed center conductor length 182.

A prepared cable insertion engagement tool 193 having rod shape, symmetrical first end and second end with longitudinal length 180 longer than cable's exposed center conductor length 182, wherein outside diameter 194 has clearance fit with inside diameter 209 of the said connector post, has round finish 188 around rod and center hole chamfer 186; longitudinal center hole, diameter 191 is clearance fit with said cable center conductor 190.

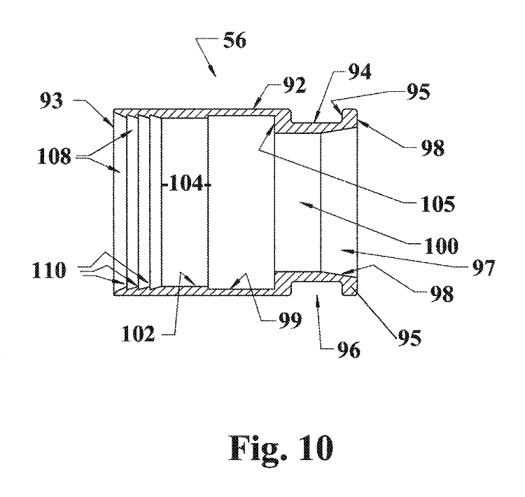

The preferred end cap 56 is best illustrated in FIGS. 10 and 5. The rigid preferably metallic end cap 56 comprises a tubular body 92 that is integral and concentric with rear neck 94 of reduced diameter. The neck 94 terminates in an outer, annular flange 95 forming the end cap rear and defining a coaxial cable input hole 100 with beveled peripheral edge 98. In all annular ring groove 96 concentrically defined about neck 94. The ring groove 96 is axially located between body 92 and flange 95 is defined by concentric, annular face 93. The external ring groove 96 is readily perceptible by touch. However, it is preferred that resilient ring 57 be seated within groove 96 in embodiments. Internal ring groove 99 seats the sealing grommet 67. Hole 97 at the rear of end cap 56 communicates with cylindrical passageway 100 concentrically located within neck 94. Passageway 100 leads to a larger diameter passageway 102 defined within end cap body 92. Ring groove 99 is disposed between passageways 100 and 102. Passageway 102 is sized to frictionally, coaxially fit over shank 48 of connector body 44 in assembly. There is an inner, annular wall 105 concentrically defined about neck 94 and facing large passageway 102 within body 92 that is a boundary between end cap body 92 and cap neck 94. Grommet 67 bears against wall 105 in operation. Once a prepared end of coaxial cable is pushed through passageway 100 and 102 it will be expanded in diameter as it is axially penetrated by post 70, and subsequent withdrawal from the connector will be resisted by contact with the deformed grommet 67 whose axial travel is resisted internal wall 105. The smooth, concentric outer surface of the connector body's shank 48 fits snugly within end cap passageway 102 when the end cap 56 telescopingly, slidably fitted to the connector body 44. Cap 56 may be firmly pushed unto the connector body 44 and then axially forced a minimal, selectable distance to semi-permanently retain the end cap 56 in place of the body coaxially frictionally attached to shank 48. There is no critical detented position that must be assumed by the end cap. The inner smooth cylindrical surface 104 of the end cap 56 is defined concentrically within body 92. Surface 104 coaxially, slidably mate with the smooth, external cylindrical surface 52 of the body shank 48. Thus the end cap 56 may be partially, telescopingly attached to the body 44, and once coax is inserted as explained below, end cap 56 may be compressed unto the body, over shank 48, until the coax end is firmly grasped and the parts are locked together. It is preferred however that the open mouth 106 at the end cap front have a plurality of concentric, spaced apart beveled rings 108 providing the end cap interior surface 104 with peripheral edges or “teeth” 110 that firmly grasp the body shank 48. Preferably there are three such “teeth” 110. When the end cap 56 is compressively mated to the body 44, teeth 110 can firmly grasp the plastic shank 48 and make a firm connection without radially compressing the connector body, which is not deformed in assembly. The end cup maybe compressed to virtually any position along the length of body shank 48 between a position just clearing annular surface 64 and the annular face 54 at rear of the body stop ring 46 forcibly contacts the annular rear wall 54 of the connector body 44. At this time the surface 64 of body shank 48 will compressively engage and deform the grommet 67, sealing the coaxial cable coaxially captivated within the compressed connector. It can be seen that when the end cap 56 is first coupled to the shank 48 of body 44, the shank 64 is axially spaced apart from the grommet 67. However, when the fitting is compressed during installation, the shank end 64 is forced into and against the grommet 67; force is directed towards coaxial cable with an added vector angle of radial and longitudinal forces to seal it. In FIG. 1C, a prepared end of coaxial cable 192 has an outer most plastic covering 185, a concentric braided metal sheath 187, laminated shield tape 204 and an inner conductor 190. When the prepared end first forced through the connector rear, passing through the connector hole 97 and through passageways 100 and 102. The coaxial cable prepared end is forced through the annulus 88, FIG. 3B, between the post 70 and the inner cylinder surface of shank 48 with post 70 coaxially penetrating the coax between the conductive braid 187 and laminated shield tape 204. The outer metallic braid is folded back, and as seen in FIG. 3D, makes electrical contact with the post 70 and portions of the end cap 56. The inner most cable conductor is routed through the post, and protrudes from the mouth 28 of the nut 30. Axial withdrawal of the coax after compression of the end cap 56 is prevented by the deformed grommet 67 and the inner wall 105, within the end cap near the jam point 120. Enhanced sealing grommet 67 is generally toroidal. In cross section it is seen that grommet 67 comprises two primary portions that are integral and coaxial. The outermost portion 130 the outer diameter of grommet 67 is of a generally squarish profile, enabling the grommet 67 snugly seat within the end cap ring groove 99 discussed earlier. The grommet length along outer portion 130 designated by the reference numeral 131, and in the best mode this distance is 3.6 mm an integral, inner bulbous grommet portion 132 has a length 134 preferably 4 mm that is larger than the outer length 131. Thus at and along its inner diameter region, grummet 67 is greater in length at its diameter region along width 131. Preferably, bulbous grommet region 132 comprises a convex nose 133 that, in assembly, points into the interior of the connector toward the head 30. A slightly inclined neck 143 transitions from the curved, outer edge 140 of the bulbous region to the outer diameter, reduce length region 131 of the grommet that preferably seats within ring groove 99. The accurate leading edge 140 of nose 133 has a radius 144, substantially establishing a semicircular geometry. Radius 144 is preferably 20% or the length of the grommet length 131 at its outer portion. When the connector is compressed, shank 48 of body 44 and end cap 56 are forced together. The enhanced sealing grommet 67 is squeezed there between. Specifically region 64 of shank 48 forcibly, contacts grommet 67 at neck 143, and deform and squeezes the grommet 67. When squeezed during installation compression, the grommet 67 deforms as in FIG. 1A. Grommet 67 is axially constrained at this time by rear annular wall 105 in the end cap. Thus, the preferred special sealing grommet 67 disposed in the end cap of the fitting is uniquely shaped with a rounded bulbous convex “nose”. This unique tends to grasp the PVC jacket and aids in locking the coax jacket in position if unusual forces applied to the coax. For example, if the coaxial cable is accidentally pulled outwardly, an axial pull, the bulbous nose 133 presses radialy inwardly on the PVC jacket of the coax, causing extra locking pressure to be exerted and further resisting the accidental extraction of the coax. The bulbous nose function as a special locking devise which reacts only when axial pressure is applied to the coax which might render the electrical connection useless if the coax were to be released outwardly any distance whatsoever from the electrical mating connection. From the foregoing, it will be seen that this invention is one well adapted to obtain all the ends and objects set forth, together with other advantages which are inherent to the structure. It will be understood that certain features and subcombination are of utility and maybe employed without reference to other features and subcombinations. This is contemplated by and is within the scope of the claims. As many possible embodiments maybe made of the invention without departing from the scope thereof, it is to be understood that all matter herein set forth or shown in the accompanying drawings is to be interpreted as illustrative and not in a limiting sense.

What is claimed is:

1. A coaxial connector for connecting a prepared end of coaxial cable to a threaded port, the coaxial cable comprising a center conductor coaxially surrounded by a insulation, the insulation coaxially surrounded by a first outer conductor, a laminated shielding tape, wherein the insulation coaxially surrounded by a laminated shielding tape is designated as “core” and said core surrounded by second outer conductor, braid, the said braid surrounded by a protective outer jacket; said connector comprising:
a) a post, a tubular conductive body, a preferred embodiment of the invention having a first end, a second end, a flange proximate the second end, a circular passageway placed between first end and second end, at least two different diameters in the said passageway wherein, in a cable-connector assembly, the said first end is adapted to penetrate into a prepared cable end around the core and coaxially beneath said braid and the second end opening of the post is adapted to be a forced fit with cable core wherein the said forced fit secures uninterrupted current flow at a high frequency through the said first outer conductor, laminated shield tape and forced fit seals the electromagnetic interference leak through the gap between the second end opening and cable core, in other words, the preferred signal propagation mode of the invention, transverse electromagnetic mode is preserved and an electromagnetically sound connector is achieved.
b) a nut having a first end attached to the post, wherein the nut is rotatable about the post and having a second end with an internally threaded bore to connect to a threaded port;
c) a connector body attached to a post by forced fit and coupled to the post by protrusion, the post and the connector body creating an outer first cavity therebetween;
d) fastener members, wherein the fastener is configured to deform the connector body or compression ring wherein said connector body or a compression ring compresses cable jacket radially against post.

2. The connector of claim 1, further comprising a post a preferred embodiment of the invention wherein second end opening of the post has an edge shape around opening with fine surface finish suitable to cleaning, resizing and reshaping of core end wherein edge shape is a round or a smooth taper to prevent core end damage during assembly operation and is usually larger than opening edge deburring finish in size.

3. The connector of claim 1, further comprising a post preferred embodiment of the invention wherein a circular passageway has a taper or a rounded step between neighboring different diameters.

4. A method of operation for the connector of claim 1, in a cable-connector assembly operation, a preferred method of the invention wherein using the second end opening of claim 2, a prepared cable core end is reshaped, resized and cleaned by pushing the prepared cable core end into the second end opening for a distance of exposed core length and pulling out.

5. A preferred insertion engagement tool of the invention, for the connector of claim 1, engaging a prepared cable core into a post first opening in a cable-connector assembling operation, having rod shape with length longer than an uncompressed connector, wherein outside diameter has clearance fit with the smallest inside diameter of the said connector post, further having first end and second end, wherein first end has center hole clearance fit with said cable center conductor, round finish around rod and center hole, wherein center hole depth is deeper than exposed center conductor length.

6. An other preferred insertion engagement tool of the invention, for the connector of claim 1, engaging a prepared cable core into a post opening in a cable-connector assembling operation, having rod shape with length longer than cable's exposed center conductor, wherein outside diameter has clearance fit with the smallest inside diameter of the said connector post, longitudinal center hole clearance fit with said cable center conductor, round finish all around rod corners and center hole.
